(19) United States
(12) Patent Application Publication
(10) Pub. No.: US 2025/0213431 A1
(43) Pub. Date: Jul. 3, 2025

(54) MEDICINE SUPPLY DEVICE

(71) Applicants: Hyengjin CHA, Suwon-si (KR); Sang Hwan JANG, Seoul (KR)

(72) Inventors: Hyengjin CHA, Suwon-si (KR); Sang Hwan JANG, Seoul (KR)

(73) Assignee: KISAN ELECTRONICS CO., LTD., Seoul (KR)

(21) Appl. No.: 18/928,322

(22) Filed: Oct. 28, 2024

(30) Foreign Application Priority Data
Dec. 27, 2023 (KR) 10-2023-0192112

(51) Int. Cl. A61J 3/00; A61J 7/00

(52) U.S. Cl. CPC A61J 3/00; A61J 7/0076

(57) ABSTRACT

A medicine supply device disclosed herein includes a transfer unit including an inlet unit configured to receive medicines, a track unit having a curved path through which the medicines from the inlet unit are transferred, and an outlet unit through which the medicines from the track unit are sequentially discharged; a vibration generating unit configured to vibrate the transfer unit to transfer the medicines from the inlet unit to the outlet unit; and a supply unit configured to supply the medicines to the inlet unit.

### CROSS REFERENCE TO PRIOR APPLICATION

This application claims the benefit of Korean Patent Application No. 10-2023-0192112, filed on Dec. 27, 2023, which is hereby incorporated by reference as if fully set forth herein.

### BACKGROUND

### Field of the Invention

The present disclosure relates to a medicine supply device in an automatic medicine packing apparatus.

### Discussion of the Related Art

Automatic medicine packing apparatus may be used in large hospitals or pharmacies to quickly pack medicines according to prescriptions and supply the medicines to patients. An automatic medicine packing apparatus includes a plurality of medicine cassettes that receive medicines in the form of tablets or capsules, and dispense the medicines one tablet or capsule at a time toward a packing unit according to an input prescription. The plurality of medicine cassettes may accommodate different types of medicines.

However, because the types of medicines are significantly diverse, a prescription may include a type of medicine that is not in the plurality of medicine cassettes in the automatic medicine packing apparatus. In preparation for such cases, a medicine supply device is included in the automatic medicine packing apparatus to, when a user of the automatic medicine packing apparatus directly inserts a plurality of medicines in the form of tablets or capsules that are not in the medicine cassettes, dispense the medicines to the packing unit one tablet or capsule at a time.

The background art of the present disclosure is disclosed in Korean Patent Registration No. 10-1014875 (registered on Feb. 8, 2011, and entitled ‘Automatic free-form tablet supplier for medicine packing apparatus, and tablet supply method thereof).

### SUMMARY

Accordingly, the present disclosure has been created to solve the above problems, and aims to provide a medicine supply device including a transfer unit configured to align and transfer a plurality of medicines while spacing the medicines apart, and that shortens a medicine transfer path of the transfer unit.

To achieve these objects and other advantages and in accordance with the purpose(s) of the invention, as embodied and broadly described herein, a medicine supply device of the present disclosure includes a transfer unit including an inlet unit configured to receive medicines, a track unit having a curved path through which the medicines are transferred, and an outlet unit through which the medicines are sequentially discharged; a vibration generating unit configured to vibrate the transfer unit to transfer the medicines from the inlet unit to the outlet unit; and a supply unit configured to supply the medicines to the inlet unit.

In another aspect of the present invention, a medicine supply device of the present disclosure includes a supply unit including a medicine container having a medicine space adapted to accommodate medicines, an open medicine discharge hole adapted to discharge the medicines, and a rotating wheel in the medicine space to rotate with respect to the medicine container to push up the medicines in the medicine space toward the medicine discharge hole; and a transfer unit including an inlet unit into which the medicines discharged from the medicine discharge hole are introduced, a track unit through which the medicines from the inlet unit are transferred, and an outlet unit through which the medicines from the track unit are discharged.

According to the present disclosure, a plurality of medicines are transferred in the track unit of the transfer unit using vibration, which may also space the medicines apart (e.g., in the track unit). Accordingly, the medicine transfer path of the transfer unit may be shortened, and a medicine supply device may be compact.

In the medicine supply device of the present disclosure, a supply unit, which is adjacent to a transfer unit, is configured to have an inclined rotatable feature that separates and discharges medicine from the supply unit to the transfer unit that is simplified and provides improved efficiency, and medicine may be fed into the supply unit without stopping the operation of the automatic medicine packing apparatus. Therefore, the productivity of medicine packing tasks may be improved.

Additional advantages, objects, and features of the invention will be set forth in part in the description which follows and in part will become apparent to those skilled in the art upon examination of the following, or may be learned from practice of the invention. The objectives and other advantages of the invention may be realized and attained by the structure(s) particularly pointed out in the written description and claims hereof as well as the appended drawings. It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a medicine supply device according to an embodiment of the present disclosure;

FIG. 2 is an exploded perspective view of the medicine supply device of FIG. 1;

FIG. 3 is a plan view of the transfer unit shown in FIG. 2;

FIG. 4 is an enlarged cross-sectional view taken along line IV-IV in FIG. 3;

FIG. 5 is a graph showing changes in the height of a bottom surface supporting medicines, along a linear path of the medicines in the transfer unit of FIG. 3;

FIG. 6 is an exploded perspective view of the transfer unit and the vibration generating unit shown in FIG. 2;

FIG. 7 is a perspective view of the supply unit shown in FIG. 2;

FIG. 8 is an exploded perspective view of the supply unit shown in FIG. 7;

FIG. 9 is an enlarged perspective view of portion IX in FIG. 8, as viewed from another angle;

FIG. 10 is a perspective view of the classification unit shown in FIG. 2, as viewed from above;

FIG. 11 is a perspective view of the classification unit shown in FIG. 2, as viewed from below;

FIG. 12 is an exploded perspective view of the classification unit shown in FIG. 2;

FIG. 13 is a front view of the interior of the housing shown in FIG. 12, showing an initial position of a classification vane before medicines are introduced into the classification unit housing;

FIG. 14 is a front view of the interior of the housing shown in FIG. 12, showing a state in which the classification vane has rotated to direct one or more medicines introduced into the classification unit toward a first outlet;

FIG. 15 is a front view of the interior of the housing shown in FIG. 12, showing a state in which the classification vane has rotated to direct medicines introduced into the classification unit toward a second outlet; and

FIG. 16 is a front view of the interior of the housing shown in FIG. 12, showing a position of the classification vane when medicines pass through and are counted in the classification unit.

### DETAILED DESCRIPTION

Hereinafter, a medicine supply device according to one or more embodiments of the present disclosure will be described in detail with reference to the accompanying drawings. The terms used in the present disclosure are for appropriately describing various embodiments of the present disclosure, and may vary depending on the intention(s) of an implementer, or precedents in the field(s) to which the present disclosure belongs. Therefore, the definitions of these terms should be based on the description throughout the present disclosure.

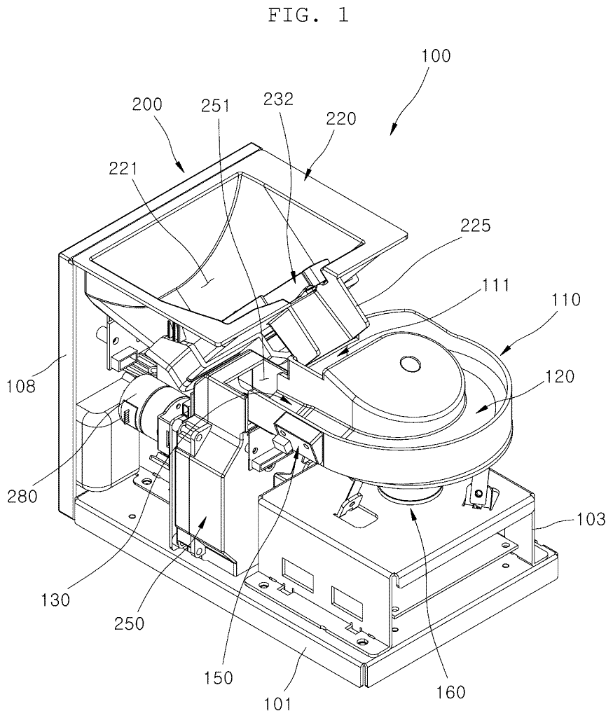

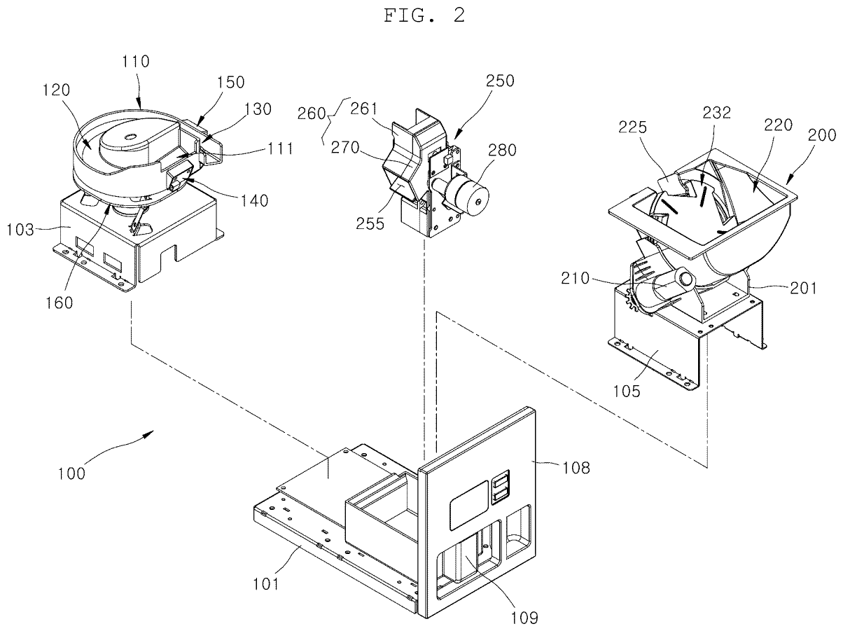

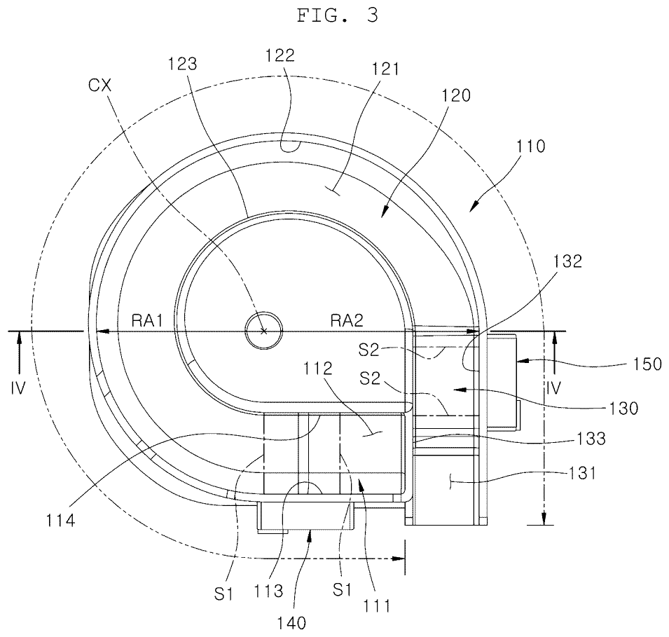

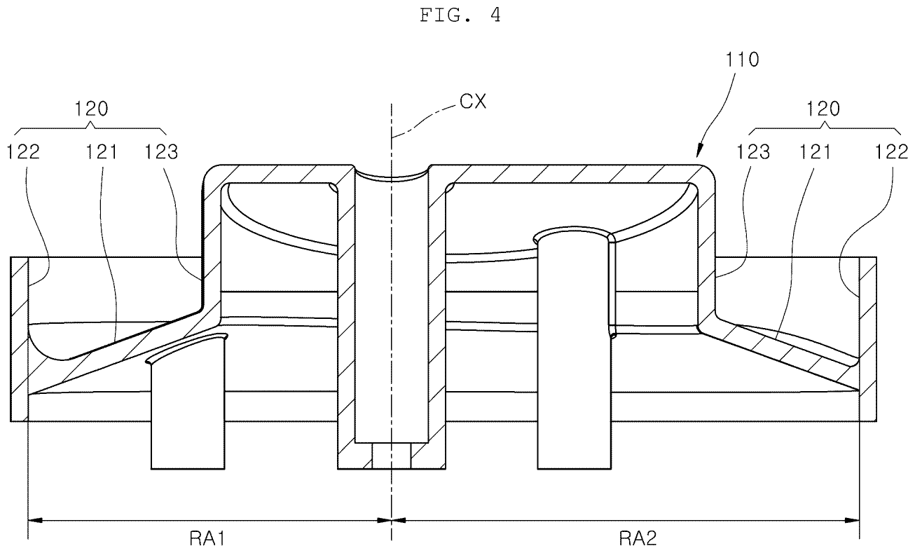

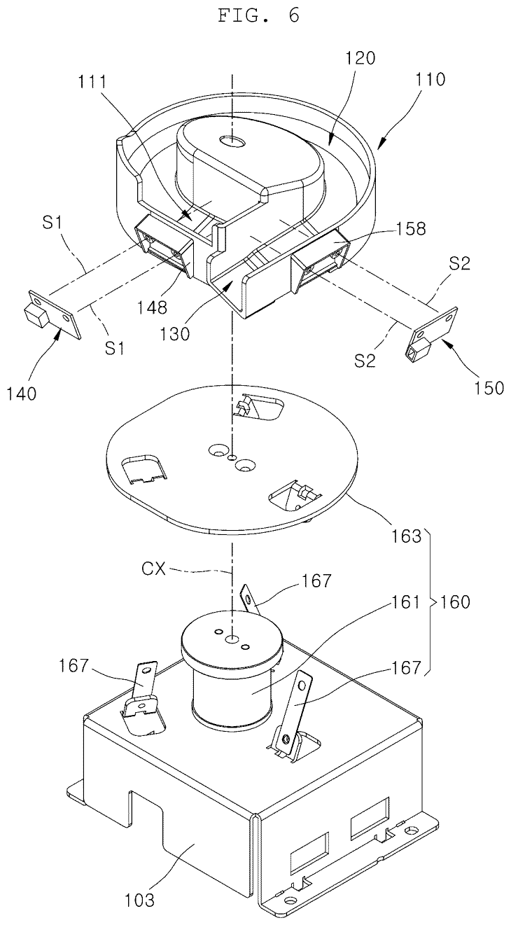

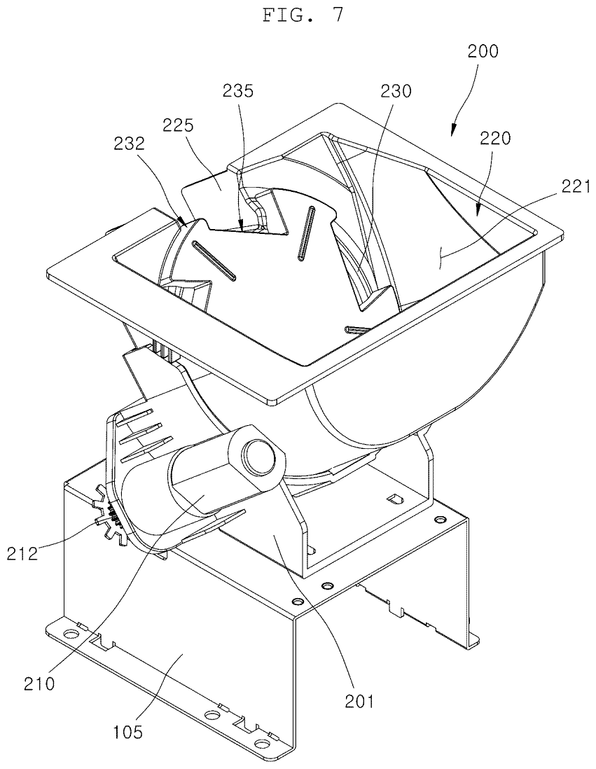

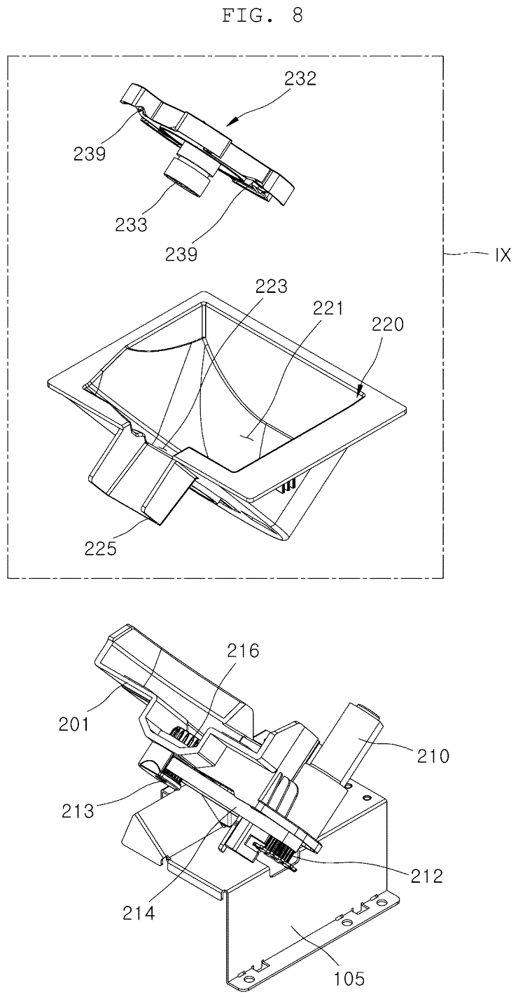

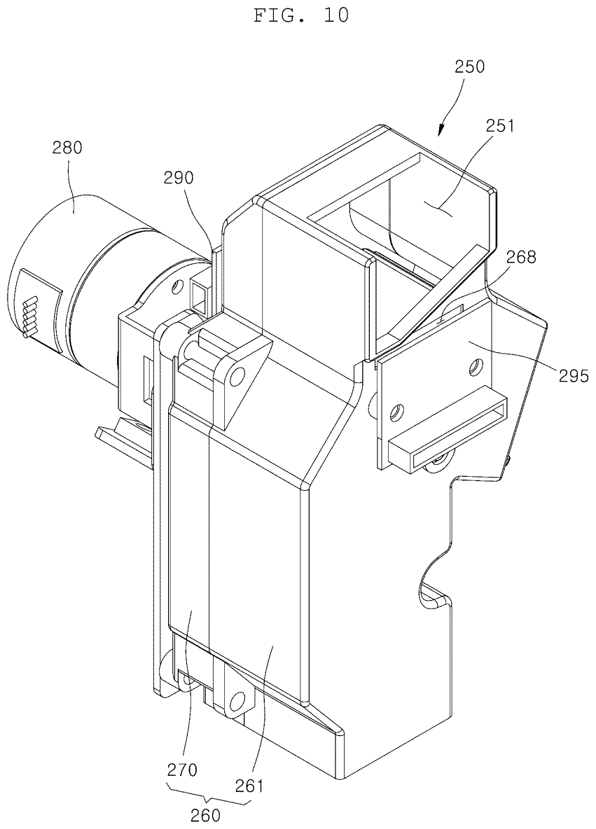

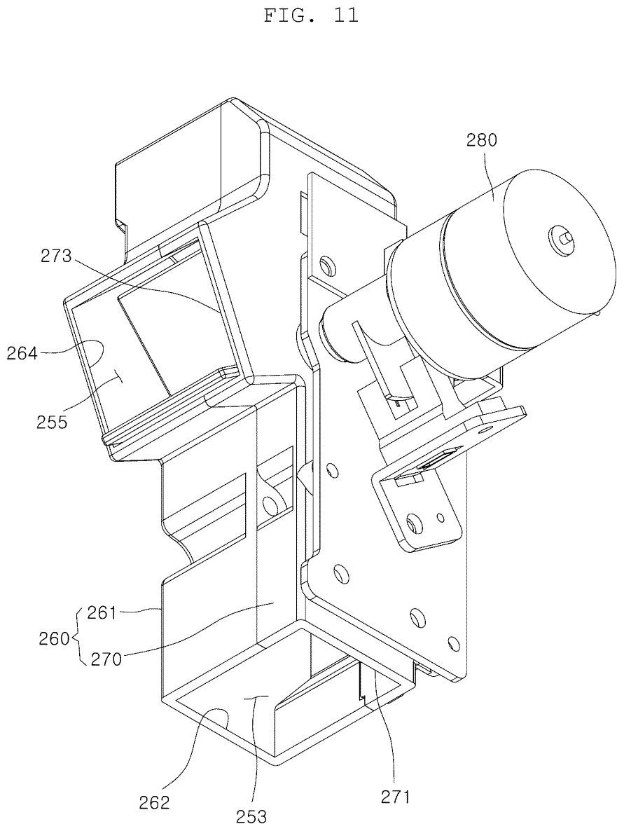

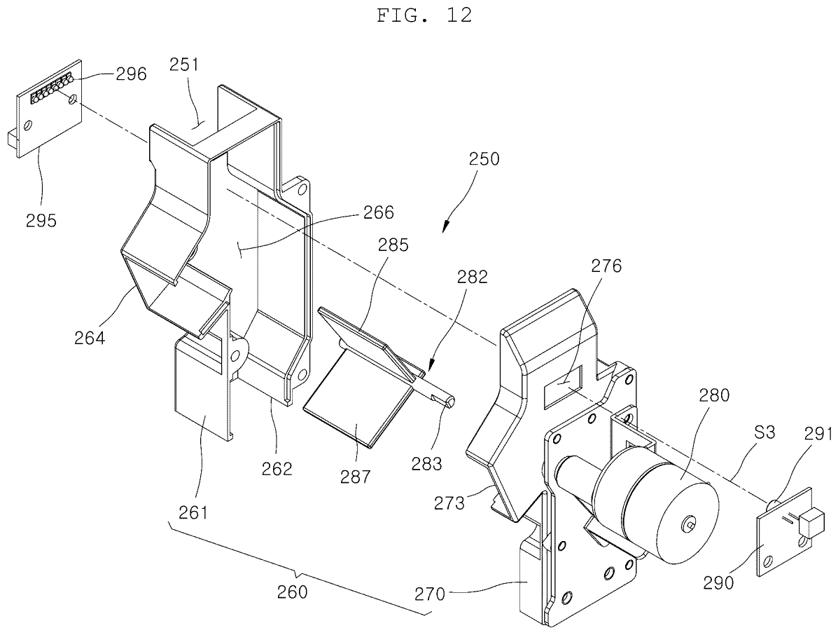

Referring to FIGS. 1 to 12, a medicine supply device 100 according to one or more embodiments of the present disclosure includes a transfer unit 110, a vibration generating unit 160, a supply unit 200, and a classification unit 250. The medicine supply device 100 may further include a base 101, a vibration generating unit support 103 that is supported by the base 101 and that supports the vibration generating unit 160, a supply unit support 105 that is supported by the base 101 and that supports the supply unit 200, and a sidewall 108 that is fixed to an end (e.g., the front end) of the base 101 and protrudes upward to fix and support a medicine container 220 of the supply unit 200.

The transfer unit 110 includes an inlet unit 111, a track unit 120, and an outlet unit 130. A medicine in the form of tablets or capsules (e.g., medicine units) enters the inlet unit 111 from the supply unit 200. In the track unit 120, the medicine units that have entered the inlet unit 111 move toward the outlet unit 130 along a curved path. The medicine units may also be spaced apart from each other while passing through the track unit 120. Through the outlet unit 130, medicines from the track unit 120 are sequentially discharged.

The inlet unit 111 is connected to one side or end of the track unit 120 (e.g., in a lengthwise direction), and the outlet unit 130 is connected to another side or end of the track unit 120 (e.g., in the lengthwise direction). The track unit 120 may extend along a curved path with a radius of curvature that gradually increases from the inlet unit 111 toward the outlet unit 130. In other words, distances RA1 and RA2 from a central axis line CX of the transfer unit 110 to an outer surface 122 of the track unit 120 may increase from the inlet unit 111 toward the outlet unit 130 along the curved path, and the radius of curvature may also gradually increase.

That is, when viewed along the line IV-IV, the distance RA1 is less than the distance RA2. It is preferable to configure the track unit 120 such that, starting from the inlet unit 111, the distance from the central axis line CX to the outer surface 122 should gradually increase in the direction of medicine transfer along the track unit 120.

In addition, the path (e.g., of the medicine) after the outlet unit 130 may be a straight line or a curved path with a radius of curvature that gradually increases or decreases.

The track unit 120 includes a bottom surface 121, an inner surface 123, and the outer surface 122. The bottom surface 121 extends along the curved path to support medicines. The inner surface 123 extends upward from the inner edge of the bottom surface 121. The outer surface 122 extends upward from the outer edge of the bottom surface 121 and faces the inner surface 123. Because the medicines are blocked by the inner surface 123 and the outer surface 122, the medicines may move along the bottom surface 121 toward the outlet unit 130 as the transfer unit 110 vibrates.

The bottom surface 121 has a height that decreases from the inner edge toward the outer edge. Because the track unit 120 extends along a curved path with a radius of curvature that increases from the inlet unit 111 toward the outlet unit 130, and the bottom surface 121 slopes from the inner edge toward the outer edge, the medicine passing through the track unit 120 moves along the curved path while being biased toward the outer edge of the bottom surface 121, and thus, the movement path of the medicines becomes longer, and when vibration is applied to the transfer unit 110, a plurality of medicine units may be spaced apart from each other along the movement path.

As the medicine units are transferred by rotational vibration along the curved path of the track unit 120 with a gradually increasing radius of curvature, the frictional forces of contact between the outer surface 122 and the surface of the medicine units decreases, such that the transfer speed of the preceding medicine units becomes slightly faster than that of the succeeding medicine units, and accordingly, the gaps between the medicine units little by little increase, resulting in the effect(s) of aligning and/or spacing apart the medicine units.

Like the track unit 120, the inlet unit 111 and the outlet unit 130 also include bottom surfaces 112 and 131, inner surfaces 114 and 133, and outer surfaces 113 and 132, respectively. The bottom surfaces 112 and 131 support the medicines or medicine units. The inner surfaces 114 and 133 extend upward from inner edges of the bottom surface 121. The outer surfaces 113 and 132 extend upward from the outer edges of the bottom surface 112 and 131 and face the inner surfaces 114 and 133, respectively. The bottom surfaces 112 and 131 are inclined or sloped such that their heights decrease from the inner edges toward the outer edges.

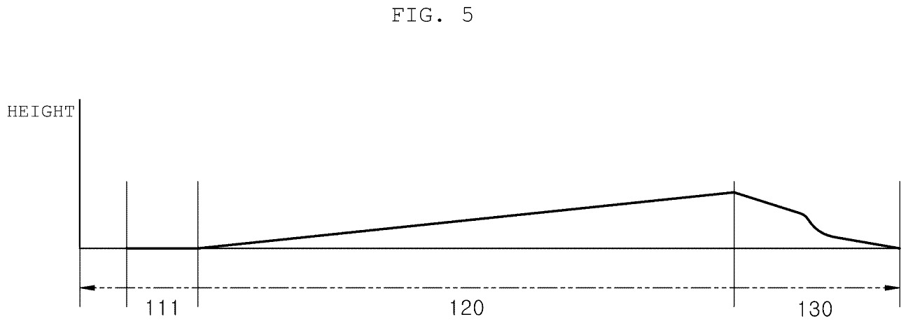

As shown in FIG. 5, along a linear path of the medicine units in the transfer unit 110, the height of the bottom surface 121 in the track unit 120 may gradually increase from the inlet unit 111 toward the outlet unit 130. The height is largest at the point where the track unit 120 and the outlet unit 130 are connected to each other, and the height decreases (slopes downward) from said point toward an end of the outlet unit 130 where the medicines are discharged from the transfer unit 110.

Contrary to the example of the present disclosure shown in FIG. 5, when the height of the track unit 120 decreases toward the outlet unit 130, the medicines may move due to vibration energy applied to the transfer unit 110, but may also slip due to gravity. Accordingly, there is a concern that the gaps between the medicines in the track unit 120 will not increase, but may not change or even decrease as the medicine units move toward the outlet unit 130. The medicines that have passed through the track unit 120 to the outlet unit 130 may slide along a downward inclined path to be discharged.

The length of the outlet unit 130 may be greater than 0 and less than half the length of the track unit 120. The length of the outlet unit 130 may be determined by considering the minimum and maximum sizes of the medicine units. In addition, the track unit 120 may extend such that the medicine units move in a curve within a length of one revolution around the central axis line CX of the transfer unit 110. The outlet unit 130 may have a curved shape to gradually get closer to the inlet unit 111 from an end of the track unit 120. Thus, the transfer unit 110 may be compact.

The transfer unit 110 may further include a transfer unit entry sensor 140 and a transfer unit discharge sensor 150. The transfer unit entry sensor 140 detects a medicine or medicine unit entering the inlet unit 111 from the supply unit 200. The transfer unit discharge sensor 150 detects a medicine in or entering the outlet unit 130.

The transfer unit entry sensor 140 and the transfer unit discharge sensor 150 may detect the medicine in a contactless manner. The transfer unit entry sensor 140 may include a light source (e.g., a light-emitting diode (LED)) that is on an entry sensor mounting unit 148 outside the outer surface 113 of the inlet unit 111 and that may emit light S1 toward the inner surface 114 of the inlet unit 111. The transfer unit entry sensor 140 may further include a light-receiving element on the inner surface 114 of the inlet unit 111. The light S1 emitted from the light source of the transfer unit entry sensor 140 may be incident on the light-receiving element.

The transfer unit discharge sensor 150 may include a light source (e.g., an LED) that is on a discharge sensor mounting unit 158 outside the outer surface 132 of the outlet unit 130 and that may emit light S2 toward the inner surface 133 of the outlet unit 130. The transfer unit discharge sensor 150 may further include a light-receiving element on the inner surface 133 of the outlet unit 130. The light S2 emitted from the light source of the transfer unit discharge sensor 150 may be incident on the light-receiving element.

The transfer unit entry sensor 140 may detect the quantity of medicine (e.g., the number of medicine units) entering the inlet unit 111 per unit time. The transfer unit discharge sensor 150 may detect the quantity of medicine (e.g., the number of medicine units) discharged from the transfer unit 110 through the outlet unit 130 per unit time. For example, when the difference between the quantity of medicine entering per unit time and the quantity of medicine discharged per unit time is greater than a preset reference value, a control unit (not shown) in the automatic medicine packing apparatus may be controlled instructed to increase the vibration intensity of the vibration generating unit 160. Alternatively, when the quantity of medicine discharged per unit time is less than the preset reference value or a second, smaller preset reference value, the control unit of the automatic medicine packing apparatus may decrease the vibration intensity of the vibration generating unit 160.

In this case, for example, when the transfer unit entry sensor 140 detects the entry of the medicine units, the medicine units may be transferred at a first speed by controlling the vibration generating unit 160, and then when the transfer unit discharge sensor 150 detects the arrival of a medicine, the medicines may be transferred intermittently, temporarily stopped, or transferred at a second speed that is lower than the first speed, by controlling the vibration generating unit 160.

The vibration generating unit 160 vibrates the transfer unit 110 to transfer the medicines or medicine units from the inlet unit 111 toward the outlet unit 130. The vibration generating unit 160 includes a vibrator 161, a vibration transmission member 163, and a spring 167. The vibrator 161 is supported by the vibration generating unit support 103. The vibrator 161 vibrates at high speed by power supplied thereto. The vibration transmission member 163 is in close

contact with and supports the transfer unit 110, and is in close contact with and supported by the vibrator 161. The vibration transmission member 163 has a roughly circular or disk shape. The shape of the vibration transmission member 163 may depend on the shape of the transfer unit 110. By fastening a fastening screw (not shown) to sequentially pass through the transfer unit 110, the vibration transmission member 163, and the vibrator 161 along the central axis line CX, the vibration transmission member 163 may be in close contact with and coupled to the vibrator 161 and the transfer unit 110.

The spring 167 elastically presses the vibration transmission member 163 to be in close contact with the vibrator 161 to cause the vibration transmission member 163 to vibrate in a circumferential direction around the central axis line CX as the vibrator 161 vibrates. Each spring 167 may be, for example, a plate spring, and the vibration generating unit 160 may comprise a plurality of plate springs 167. The plurality of plate springs 167 may be at equal angular intervals with respect to the central axis line CX.

Because the upper ends of the plurality of plate springs 167 are obliquely coupled to the vibration transmission member 163, and the lower ends of the plurality of plate springs 167 are coupled to the vibration generating unit support 103, the vibration transmission member 163 and the transfer unit 110 fixed to the vibration transmission member 163 may rapidly vibrate in the circumferential direction around the central axis line CX from the vibration of the vibrator 161.

The supply unit 200 supplies the medicine or medicine units to the inlet unit 111. The supply unit 200 includes the medicine container 220 and a rotating wheel 232. A medicine space 221 in which the medicine or medicine units fall and that accommodates the medicine or medicine units, and an open medicine discharge hole 223 for the medicines to pass into the inlet unit 111 are in the medicine container 220. The upper side of the medicine container 220 may be open such that the user may freely drop the medicine into the medicine space 221. Here, the supply unit 200 may further include a cover unit (not shown) that allows the user to open and close the medicine space 221 to retrieve remaining medicine or medicine units, or replenish the supply unit 200 with the medicine.

The rotating wheel 232 is in the medicine space 221. The rotating wheel 232 rotates with respect to the medicine container 220 to push up the medicines in the medicine space 221 toward the medicine discharge hole 223. The medicine discharge hole 223 is higher than the inlet unit 111, so that the medicine discharged through the medicine discharge hole 223 may fall by gravity into the inlet unit 111.

The supply unit 200 may further include a medicine discharge channel 225, a motor frame 201, and an electric motor 210. The medicine discharge channel 225 guides the medicine discharged through the medicine discharge hole 223 into the inlet unit 111. The motor frame 201 is fixed to and/or supported by the supply unit support 105. The electric motor 210 is supported by the motor frame 201. The electric motor 210 rotates the rotating wheel 232.

The rotating wheel 232 includes a rotating shaft unit 233 protruding from its rotation center RC. A connecting groove or opening having a concave spline (e.g., gear) pattern on the inner surface thereof is at an end of the rotating shaft unit 233. A shaft through-hole 227 through which the rotating wheel shaft unit 233 passes is on a surface 228 of the medicine container 220 that faces the rotating wheel 232.

A spline shaft 216 that fits into the connecting groove of the rotating shaft unit 233 and having a convex spline (e.g., gear) pattern on the outer circumferential surface thereof configured to mesh with the concave spline pattern at one end of the rotating shaft unit 233 and rotate may pass through the motor frame 201. A driven pulley 213 is coaxially coupled to the other end of the spline shaft 216.

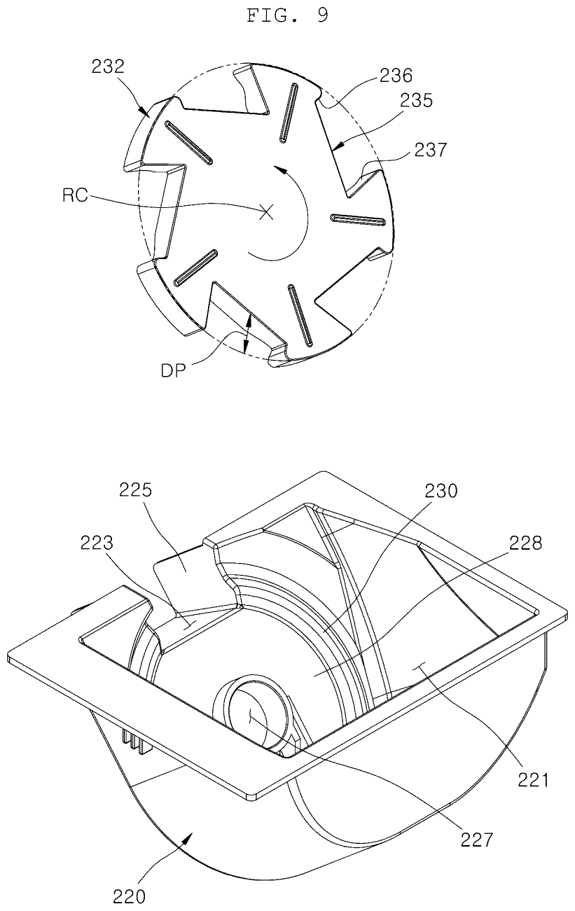

A driving pulley 212 is coaxially coupled to the motor shaft of the electric motor 210, and a belt 214 connects the driving pulley 212 to the driven pulley 213 to enable transmission of rotational power to the spline shaft 216. With the configuration described above, when the motor shaft of the electric motor 210 rotates, the rotating wheel 232 rotates (e.g., in the direction of the arrow illustrated in FIG. 9) to push the medicine or medicine units in the medicine space 221 up toward the medicine discharge hole 223.

A dent 235 that is recessed inward (that is, toward the rotation center RC) may be in the outer circumferential surface of the rotating wheel 232. A plurality of dents 235 may be in the rotating wheel 232. The plurality of dents 235 may be at equal angular intervals. All or some of the medicine or medicine units (e.g., in the medicine space 221) may be transported in the dent 235. When the dent 235 moves toward the medicine discharge hole 223 as the rotating wheel 232 rotates, one or more medicine units in the dent 235 are pushed up toward the medicine discharge hole 223.

The dent 235 is sloped, such that the distance (e.g., of the edge of the dent 235) to the rotation center RC of the rotating wheel 232 decreases from a dent front end 236 toward a dent rear end 237. In other words, a depth DP of the dent 235 the rotation center RC and/or away from the outer circumference of the rotating wheel 232 increases from the dent front end 236 toward the dent rear end 237. When the rotating wheel 232 rotates, the dent front end 236 of one dent 235 passes over the medicine discharge hole 223 earlier than the dent rear end 237.

The medicine container 220 includes a jam prevention unit 230 protruding from the surface 228 that faces the rotating wheel 232, and the rotating wheel 232 may include a protrusion accommodation groove 239 corresponding to the jam prevention unit 230. The jam prevention unit 230 extends along an arc centered on the rotation center RC of the rotating wheel 232. The jam prevention unit 230 may have a certain radius from the rotation center RC and may be exposed through the dent(s) 235.

The cross-sectional shape of the jam prevention unit 230 (e.g., in a direction intersecting the lengthwise direction of the jam prevention unit 230) is a sloped shape, such as a sawtooth shape, a gear tooth shape, a hemispherical or circular segment shape, for a triangular shape. The protrusion accommodation groove 239 may be concave and/or recessed such that rotation of the rotating wheel 232 is not hindered by the jam prevention unit 230. The cross-sectional shape of the protrusion accommodation groove 239 corresponds and/or is complementary to the cross-sectional shape of the jam prevention unit 230.

Due to the protrusion of the jam prevention unit 230, the medicine or medicine units in the dent 235 are separated by the jam prevention unit 230, and may be distributed in the dent 235 on opposite sides of the jam prevention unit 230 (e.g., one medicine unit toward the rotation center RC and one medicine unit away from the rotation center RC, separated by the jam prevention unit 230). Thus, an operational error in which the rotating wheel 232 does not rotate due to the medicine being caught between the rotating wheel 232 and the rotating wheel facing surface 228 may be prevented.

The rotation speed of the rotating wheel 232 may vary according to the quantity of medicine (e.g., the number of medicine units) detected by the transfer unit entry sensor 140. In detail, when the quantity of medicine entering per unit time detected by the transfer unit entry sensor 140 is greater than a preset maximum reference value, the rotation speed of the rotating wheel 232 may decrease. On the contrary, when the quantity of medicine entering per unit time is less than a preset minimum reference value, the rotation speed of the rotating wheel 232 may increase.

In addition, the rotation speed of the rotating wheel 232 may vary according to the size of the medicine (e.g., when the medicine is large, the rotating wheel 232 rotates faster). In addition, the rotation speed of the rotating wheel 232 may decrease after discharge of the medicine is detected by the transfer unit entry sensor 140.

Referring to FIGS. 1, 2 and 10 to 15, the classification unit 250 guides the medicine or medicine units discharged from the outlet unit 130 toward one of a first falling path and a second falling path, which are distinct from each other.

The classification unit 250 includes a classification unit housing 260, classification sensors 290 and 295, and a classification vane 282. An inlet 251 receiving medicine 10 discharged from the outlet unit 130, a first outlet 253 through which the medicine 10 is discharged to the first falling path, and a second outlet 255 through which the medicine 10 is discharged to the second falling path are in the classification unit housing 260.

The first falling path is a path that guides the medicine 10 toward a packing unit (not shown) below the automatic medicine packing apparatus. Through the first falling path, the medicine 10 may be introduced into a hopper (not shown), pass through the hopper, and then enter the packing unit. The second falling path is a path that guides the medicine 10 to be collected separately, without heading to the packing unit.

The classification unit housing 260 includes a housing base 261 and a housing cover 270 coupled to the housing base 261. The inlet 251 is at the upper end of the housing base 261. The first outlet 253 is defined by a first outlet groove portion 262 at the lower end of the housing base 261, and a first outlet groove portion 271 at the lower end of the housing cover 270.

The second outlet 255 is defined by a second outlet groove portion 264 in an intermediate portion of the housing base 261 in the vertical direction, and a second outlet groove portion 273 in an intermediate portion of the housing cover 270 in the vertical direction. The classification unit housing 260 includes an internal space 266 including the rotatable classification vane 282.

The classification sensors 290 and 295 may detect the medicine 10 in the inlet 251 in a contactless manner. The classification sensors 290 and 295 may include a light-emitting unit 290 fixed to and/or supported by an upper portion of the housing cover 270, and a light-receiving unit 295 fixed to and/or supported by an upper portion of the housing base 261.

The light-emitting unit 290 may include a light source 291 (e.g., an LED) in the housing cover 270, configured to emit light S3 into the classification unit housing 260. A light-transmitting window 276 that is open to allow the light S3 from the light source 291 to pass therethrough may be in the housing cover 270.

The light-receiving unit 295 may include a light-receiving element 296 in the housing base 261. The light S3 emitted from the light source 291 may be incident on the light-receiving element 296. The light-receiving unit 295 may comprise a plurality of light-receiving elements 296. An open light-transmitting window 268 in the housing base 261 allows the light S3 from the light source 291 to pass therethrough and then be incident on the light-receiving element 296.

The classification vane 282 rotates to direct the medicine 10 toward the first outlet 253 when the classification sensors 290 and 295 detect a first (e.g., good) state of the medicine 10 (e.g., when the number of medicine units is equal to a preset number, such as 1 or 2), and rotates to direct the medicine 10 toward the second outlet 255 when the classification sensors 290 and 295 detect a second (e.g., bad) state of the medicine 10 (e.g., when more than the preset number of medicine units are detected).

The classification vane 282 includes a vane shaft 283 extending parallel to the direction of the light S3 from the light source 291, and a first blade 285 and a second blade 287 that protrude radially from the vane shaft 283. The second blade 287 is more biased toward the second outlet 255 than the first blade 285. The first blade 285 and the second blade 287 protrude from the vane shaft 283 with a certain angle therebetween. Thus, the cross-sectional shape of the classification vane 282 may comprise a ‘V’ shape.

The classification unit 250 may further include an electric motor 280 that rotates the classification vane 282. The electric motor 280 may be supported by the classification unit housing 260.

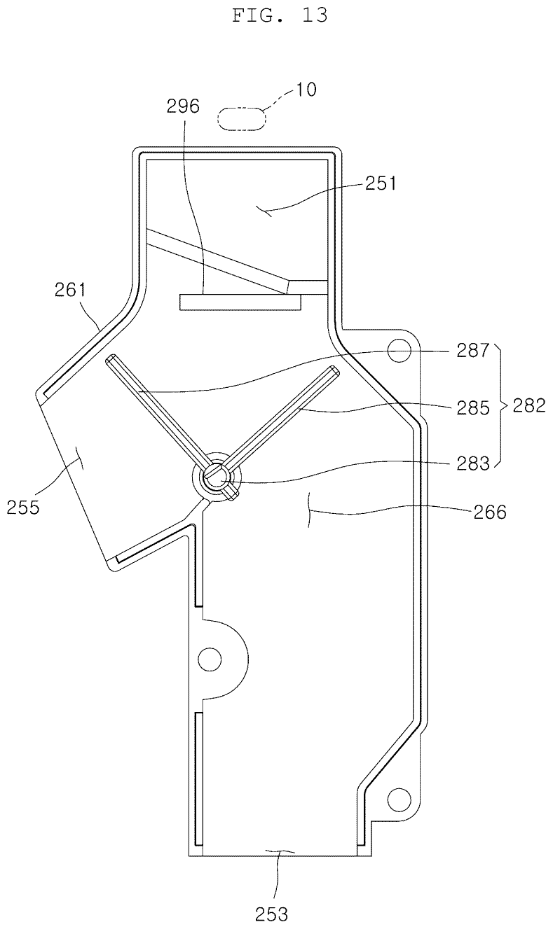

The initial position of the classification vane 282 before the medicine 10 are introduced into the internal space 266 of the classification unit housing 260 through the inlet 251 of the classification unit 250 is as illustrated in FIG. 13. When the classification vane 282 is in the initial position, a passage leading to the first outlet 253 is closed by the first blade 285, and a passage leading to the second outlet 255 is closed by the second blade 287.

When the medicine 10 is discharged from the outlet unit 130 and introduced into the classification unit housing 260 through the inlet 251, the state of the medicine 10 (e.g., the number of medicine units) is detected by the classification sensors 290 and 295. The medicine 10 passing through the inlet 251 may temporarily stay in the space (e.g., a V-shaped groove) between the first blade 285 and the second blade 287.

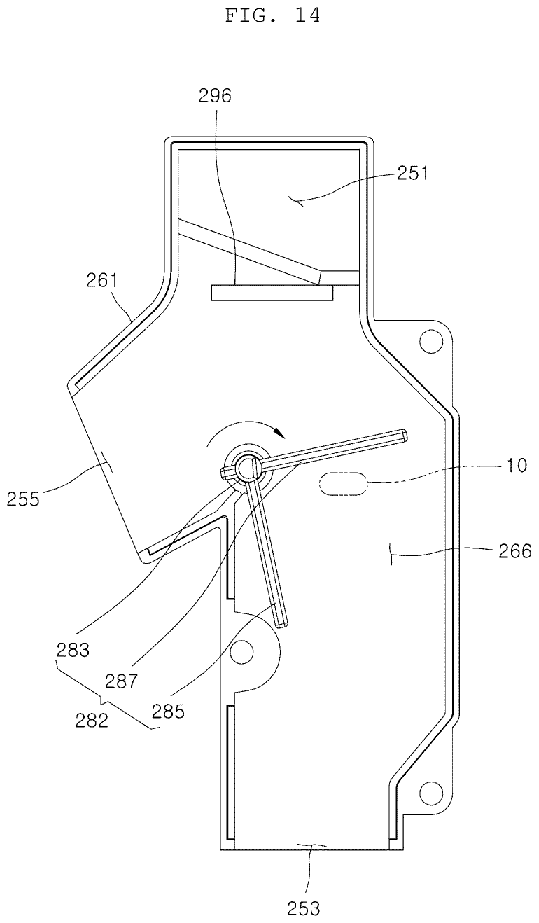

When the classification sensors 290 and 295 detect that the state of the medicine 10 is “good,” as illustrated in FIG. 14, the classification vane 282 rotates in the clockwise direction in FIG. 14 so that the medicine 10 in the V-shaped groove is discharged through the first outlet 253.

A through-hole aligned with the first outlet 253 may be in the base 101. The medicine 10 discharged through the first outlet 253 may pass through the through-hole in the base 101 and fall along the first falling path as described above.

In detail, as the classification vane 282 rotates in the clockwise direction, the first blade 285 opens the passage leading to the first outlet 253, and the second blade 287 pushes the medicine 10 toward the first outlet 253. A “good” state of the medicine 10 may mean, for example, that the medicine 10 is not damaged and one unit (or a different preset number of units) corresponding to a single dose is in the classification unit housing 260.

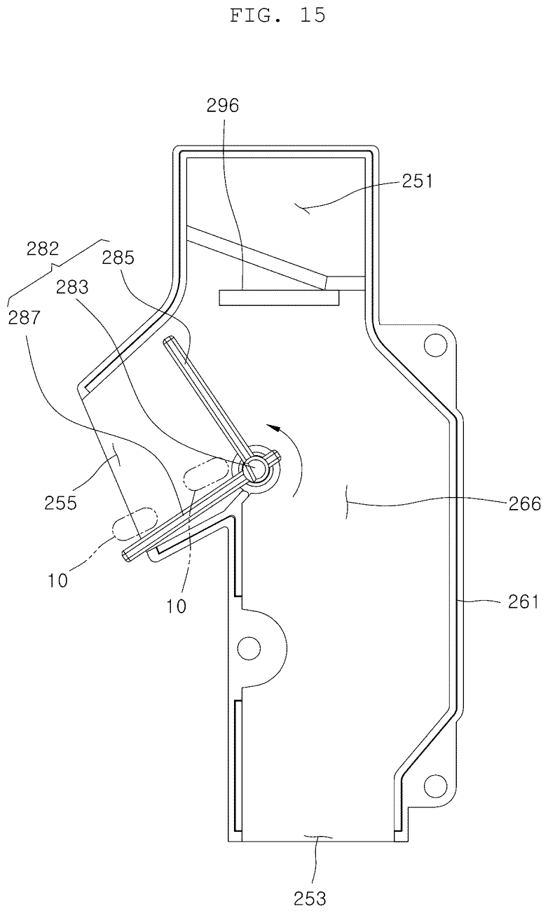

When the classification sensors 290 and 295 detect that the state of the medicine 10 is “bad,” as illustrated in FIG. 15, the classification vane 282 rotates in the counterclockwise direction in FIG. 15 so that the medicine 10 in the V-shaped groove may be discharged through the second outlet 255.

In detail, as the classification vane 282 rotates in the counterclockwise direction, the second blade 287 opens the passage leading to the second outlet 255, and the first blade 285 pushes the medicine 10 toward the second outlet 255. A “bad” state of the medicine 10 may mean, for example, that the medicine 10 is damaged or that a number of the medicine units 10 different from the preset number (e.g., corresponding to a single dose) are in the classification unit housing 260.

The medicine supply device 100 may further include a medicine collection unit 109 configured to collect the medicine 10 discharged from the classification unit housing 260 through the second outlet 255. The medicine collection unit 109 may be inserted through an opening in the sidewall 108, below the second outlet 255. The medicine 10 discharged through the second outlet 255 may move along the second falling path and be collected in the medicine collection unit 109.

When all of the medicine in the dose is in the medicine collection unit 109, the user may withdraw the medicine collection unit 109 from the medicine supply device 100 through the opening in the sidewall 108, empty the medicine collection unit 109, and then insert the medicine collection unit 109 back below the second outlet 255 through the opening in the sidewall 108.

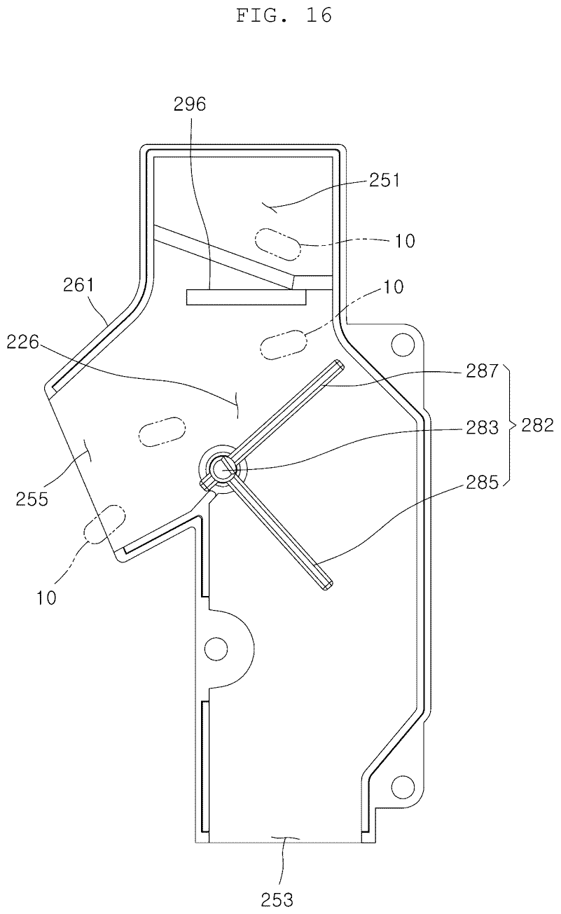

Meanwhile, the classification unit 250 may also be used to count the number of medicines and/or medicine units 10. In this case, the classification vane 282 is set as illustrated in FIG. 16 so that the second blade 287 closes the passage leading to the first outlet 253, and the passage leading to the second outlet 255 is open.

In this state, when a plurality of medicines and/or medicine units 10 are introduced into the classification unit housing 260 through the inlet 251, the number of medicines and/or medicine units 10 is counted by the classification sensors 290 and 295. The counted medicines/medicine units 10 are discharged through the second outlet 255 and then collected in the medicine collection unit 109.

The classification unit 250 is between the supply unit 200 and the transfer unit 110. Because the classification unit 250 does not occupy an additional space in the medicine supply device 100, but is in an extra space between the supply unit 200 and the transfer unit 110, the medicine supply device 100 may be easily miniaturized.

Although the present disclosure has been described with reference to the embodiments illustrated in the drawings, they are merely exemplary, and those skilled in the art will understand that various modifications and equivalent embodiments may be made therefrom. Therefore, the scope of the present disclosure should be defined only by the following claims.

What is claimed is:

1. A medicine supply device comprising:
a transfer unit including an inlet unit configured to receive medicines, a track unit having a curved path through which the medicines from the inlet unit are transferred, and an outlet unit through which the medicines from the track unit are sequentially discharged;
a vibration generating unit configured to vibrate the transfer unit to transfer the medicines from the inlet unit to the outlet unit; and
a supply unit configured to supply the medicines to the inlet unit.

2. The medicine supply device of claim 1, wherein the track unit extends along the curved path with a radius of curvature that gradually increases from the inlet unit toward the outlet unit.

3. The medicine supply device of claim 2, wherein the track unit comprises an inclined bottom surface that supports the medicines and extends along the curved path, and the bottom surface has a height that decreases from an inner edge of the bottom surface toward an outer edge of the bottom surface.

4. The medicine supply device of claim 1, wherein the track unit has a bottom surface supporting the medicines that has a height that increases away from the inlet unit along a linear path of the medicines, and the outlet unit has a bottom surface that slopes downward away from the track unit.

5. The medicine supply device of claim 1, further comprising a classification unit configured to guide the medicines from the outlet unit toward a first falling path or a second falling path.

6. The medicine supply device of claim 1, wherein the transfer unit further comprises a transfer unit discharge sensor configured to detect the medicines in the outlet unit, and
when the transfer unit discharge sensor detects the medicines being transferred at a first speed, the vibration generating unit is controlled such that the medicines are transferred intermittently, temporarily stopped, or transferred at a second speed that is lower than the first speed.

7. A medicine supply device comprising:
a supply unit including a medicine container having a medicine space adapted to accommodate medicines, an open medicine discharge hole adapted to discharge the medicines, and a rotating wheel in the medicine space and configured to rotate with respect to the medicine container to push up the medicines in the medicine space toward the medicine discharge hole; and
a transfer unit including an inlet unit configured to receive the medicines discharged from the medicine discharge hole, a track unit through which the medicines from the inlet unit are transferred, and an outlet unit through which the medicines from the track unit are discharged.

8. The medicine supply device of claim 7, wherein the medicine discharge hole is higher than the inlet unit, and the medicines discharged through the medicine discharge hole fall by gravity into the inlet unit.

9. The medicine supply device of claim 7, wherein the rotating wheel has an outer circumferential surface with a dent that is recessed inward,
the dent has a front end and a rear end, and
a distance between the dent and a rotation center of the rotating wheel decreases from the front end toward the rear end in a direction of rotation of the rotating wheel.

10. The medicine supply device of claim 9, wherein the medicine container comprises a jam prevention unit that protrudes from a surface of the medicine container and faces the rotating wheel, has an inclined cross-sectional shape, and extends along an arc centered on the rotation center of the rotating wheel, and
a protrusion accommodation groove corresponding to the jam prevention unit on one surface of the rotating wheel.

11. The medicine supply device of claim 7, wherein the transfer unit further comprises a transfer unit entry sensor configured to detect the medicines entering the inlet unit, and
a rotation speed of the rotating wheel depends on a quantity or size of the medicines detected by the transfer unit entry sensor.

12. The medicine supply device of claim 7, further comprising a classification unit configured to guide the medicines from the outlet unit toward a first falling path or a second falling path.

13. The medicine supply device of claim 5, wherein the classification unit comprises:
a classification unit housing having an inlet configured to receive the medicines from the outlet unit, a first outlet through which the medicines go to the first falling path, and a second outlet through which the medicines go to the second falling path;
a classification sensor configured to detect the medicines in the inlet; and
a classification vane configured to rotate to direct the medicines toward the first outlet when the classification sensor detects a first state of the medicines, and to rotate to direct the medicines toward the second outlet when the detects a second state of the medicines.

14. The medicine supply device of claim 5, wherein the classification unit is between the supply unit and the transfer unit.

15. The medicine supply device of claim 12, wherein the classification unit comprises:
a classification unit housing having an inlet configured to receive the medicines from the outlet unit, a first outlet through which the medicines go to the first falling path, and a second outlet through which the medicines go to the second falling path;
a classification sensor configured to detect the medicines in the inlet; and
a classification vane configured to rotate to direct the medicines toward the first outlet when the classification sensor detects a first state of the medicines, and to rotate to direct the medicines toward the second outlet when the classification sensor detects a second state of the medicines.

16. The medicine supply device of claim 12, wherein the classification unit is between the supply unit and the transfer unit.

17. The medicine supply device of claim 1, wherein the track unit is configured to space the medicines apart from each other while passing through the track unit.
